(19) United States
(12) Patent Application Publication
(10) Pub. No.: US 2006/0201352 A1
(43) Pub. Date: Sep. 14, 2006

(54) Roller rotary drive transmitting apparatus

(75) Inventor: Nobuaki Saito, Ibaraki (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Komori Corporation

(21) Appl. No.: 11/369,585

(22) Filed: Mar. 6, 2006

(30) Foreign Application Priority Data
Mar. 9, 2005 (JP) 065374/2005

(51) Int. Cl. B41F 5/00

(52) U.S. Cl. 101/216

(57) ABSTRACT

A roller rotary drive transmitting apparatus includes an internal gear, sun gear, at least one planet gear, carrier, anilox roller, and controller. The internal gear is rotatably driven by a printing press motor. The sun gear is rotatably driven by an anilox roller motor. The planet gear meshes with the sun gear and internal gear. The carrier rotatably supports the planet gear and rotates around the sun gear when at least one of the internal gear and sun gear rotates. The roller is connected to the carrier and rotates upon rotation of the carrier. The controller controls the anilox roller motor in an operative state when the printing press motor is kept stopped.

### BACKGROUND OF THE INVENTION

The present invention relates to a roller rotary drive transmitting apparatus applied to an anilox roller or the like to apply varnish to a printing product.

In a roller rotary drive transmitting apparatus of this type, an anilox roller is rotated, even after printing is ended and the anilox roller is thrown off a varnish supply cylinder, to prevent varnish from drying. More specifically, while the anilox roller is thrown on the varnish supply cylinder, the anilox roller is driven by a printing press driving motor (to be referred to as a printing press motor hereinafter) which also serves as a driving source for the varnish supply cylinder, so the varnish film thickness will not be fluctuated by relative rotational fluctuation. After the printing is ended, when the printing press motor is stopped, the motor is switched to a dedicated anilox roller motor, so the anilox roller is rotated constantly. In order to switch between a driving system from the printing press motor and a driving system from the dedicated motor, clutches are provided.

As shown in U.S. Pat. No. 4,569,306, a conventional apparatus incorporates a varnish form roller which can be thrown on/off a blanket cylinder, the first one-way clutch which is arranged between the cylinder gear of the blanket cylinder and the form roller gear of the varnish form roller, and the second one-way clutch which is arranged between a motor dedicated to drive the varnish form roller and the form roller gear of the varnish form roller. In this arrangement, when the varnish form roller is impression throw-on the blanket cylinder, the rotation of the printing press motor is transmitted to the varnish form roller through the first one-way clutch. When the varnish form roller is impression throw-off the blanket cylinder, the rotation of the motor dedicated to drive the varnish form roller is transmitted to the varnish form roller.

In the conventional roller rotary drive transmitting apparatus described above, when inner and outer rings idle, a roller or sprag which constitutes the one-way clutch slides on the inner and outer rings in contact with each other to cause a problem in durability. A blanket cylinder which rotates in contact with the varnish form roller has a notch in its outer surface. When the varnish form roller opposes this notch, a large load fluctuation occurs. A large fluctuating load accordingly acts among the roller or sprag and the inner and outer rings to nonuniformly wear or deform them. Since the two one-way clutches must be provided, the manufacturing cost increases.

### SUMMARY OF THE INVENTION

It is an object of the present invention to provide a roller rotary drive transmitting apparatus with improved durability.

It is another object of the present invention to provide a roller rotary drive transmitting apparatus with a decreased manufacturing cost.

In order to achieve the above objects, according to the present invention, there is provided a roller rotary drive transmitting apparatus comprising an internal gear which is rotatably driven by a first driving source, a sun gear which is rotatably driven by a second driving source, at least one planet gear which meshes with the sun gear and the internal gear, a carrier which rotatably supports the planet gear and rotates around the sun gear when at least one of the internal gear and the sun gear rotates, a roller which is connected to the carrier and rotates upon rotation of the carrier, and control means for controlling the second driving source in an operative state while the first driving source is kept stopped.

### BRIEF DESCRIPTION OF THE DRAWINGS

FIG. 1 is a side view of a sheet-fed offset rotary printing press to which the present invention is applied;

FIG. 2 is a view of the roller array of the sheet-fed offset rotary printing press shown in FIG. 1 and shows a state at the start of coating;

FIG. 3 is a view of the roller array of the sheet-fed offset rotary printing press shown in FIG. 1 and shows a state at the end of coating;

FIG. 4 is a side view of a cylinder throw on/off mechanism in a coating device shown in FIG. 1;

FIG. 5 is a sectional view showing the main part of a rotary drive transmitting apparatus according to the first embodiment of the present invention;

FIGS. 6A and 6B are front and exploded perspective views, respectively, of a planet gear train shown in FIG. 5;

FIG. 7 is a view showing the drive transmission path of the gear of the rotary drive transmitting apparatus shown in FIG. 5;

FIG. 8 is a block diagram showing the electrical arrangement of a sheet-fed offset rotary printing press which incorporates the rotary drive transmitting apparatus shown in FIG. 5; and

FIG. 9 is a block diagram showing the second embodiment of the present invention.

### DESCRIPTION OF THE PREFERRED EMBODIMENTS

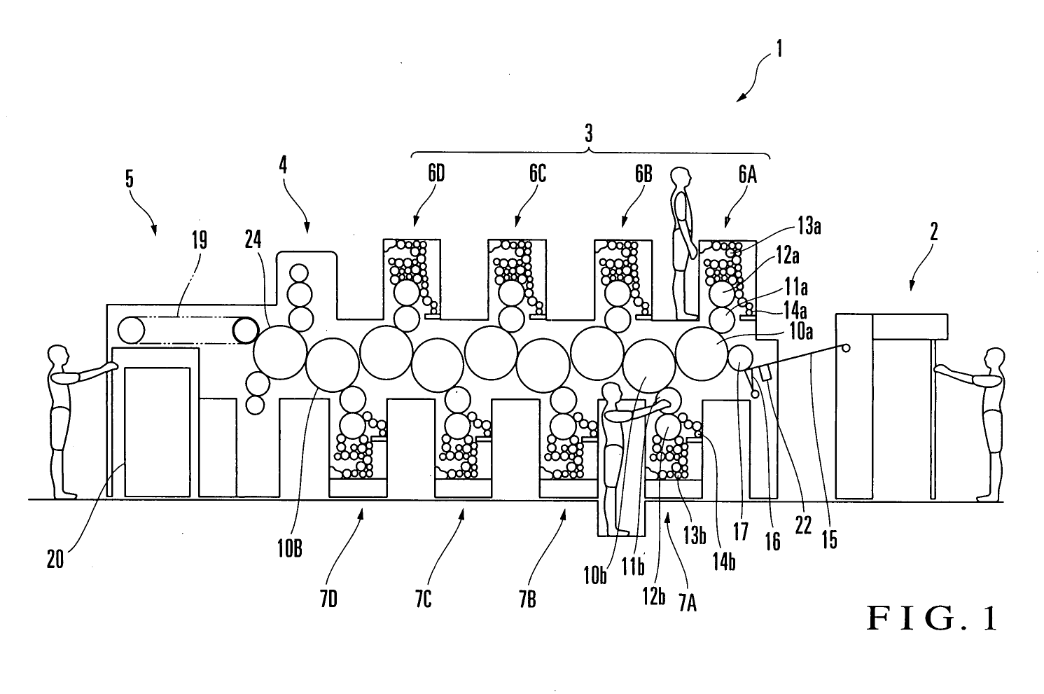

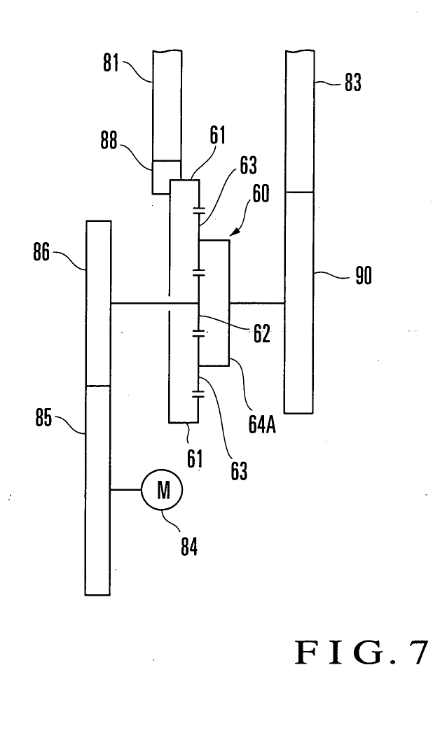

A roller rotary drive transmitting apparatus according to the first embodiment of the present invention will be described with reference to FIGS. 1 to 8. As shown in FIG. 1, a sheet-fed offset rotary printing press 1 comprises a feed device 2 which feeds a sheet, a printing unit 3 which prints on the sheet fed from the feed device 2, a coating unit 4 which coats the obverse and reverse surfaces of the sheet printed by the printing unit 3 with varnish, and a delivery unit 5 which delivers the sheet coated by the coating unit 4. The printing unit 3 comprises four obverse surface printing units 6A to 6D which correspond to four different colors, and four reverse surface printing units 7A to 7D which correspond to four different colors.

Each of the obverse surface printing units 6A to 6D includes a double-sized diameter impression cylinder 11a provided with grippers on its outer surface which grip the sheet, a blanket cylinder 11a which is located above the impression cylinder 10a to oppose it, a plate cylinder 12a which is located above the blanket cylinder 11a to oppose it, an inking device 13a which supplies ink to the plate cylinder 12a, and a dampening device 14a which supplies water to the plate cylinder 12a.

Each of the reverse surface printing units 7A to 7D includes a double-sized diameter impression cylinder 10b provided with grippers on its outer surface which grip the sheet, a blanket cylinder 11b which is located under the impression cylinder 10b to oppose it, a plate cylinder 12b which is located under the blanket cylinder 11b to oppose it, an inking device 13b which supplies ink to the plate cylinder 12b, and a dampening device 14b which supplies water to the plate cylinder 12b.

In this arrangement, the leading edge of the sheet fed from the feed device 2 onto a feeder board 15 is gripped by a swing arm shaft pregripper 16 and supplied to the obverse surface printing unit 6A through a transfer cylinder 17. The sheet fed to the obverse surface printing unit 6A is gripping-changed to the grippers of the impression cylinder 10a and printed with the first color on its obverse surface as it passes through the opposing point of the impression cylinder 11a and blanket cylinder 11a. The sheet printed with the first color on its obverse surface is gripping-changed to the impression cylinder 10b of the first reverse surface printing unit 7A and printed with the first color on its reverse surface as it passes through the opposing point of the impression cylinder 10b and blanket cylinder 11b.

Similarly, the sheet which is printed with four colors on its obverse and reverse surfaces by the obverse surface printing units 6B to 6D and reverse surface printing units 7B to 7D is coated with varnish on its obverse and reverse surfaces by the coating unit 4, as will be described later. The varnish-coated sheet is gripping-changed to the delivery grippers (not shown) of a delivery chain 19 of the delivery unit 5, is conveyed by the delivery chain 19, and falls on a delivery pile 20 and is stacked there.

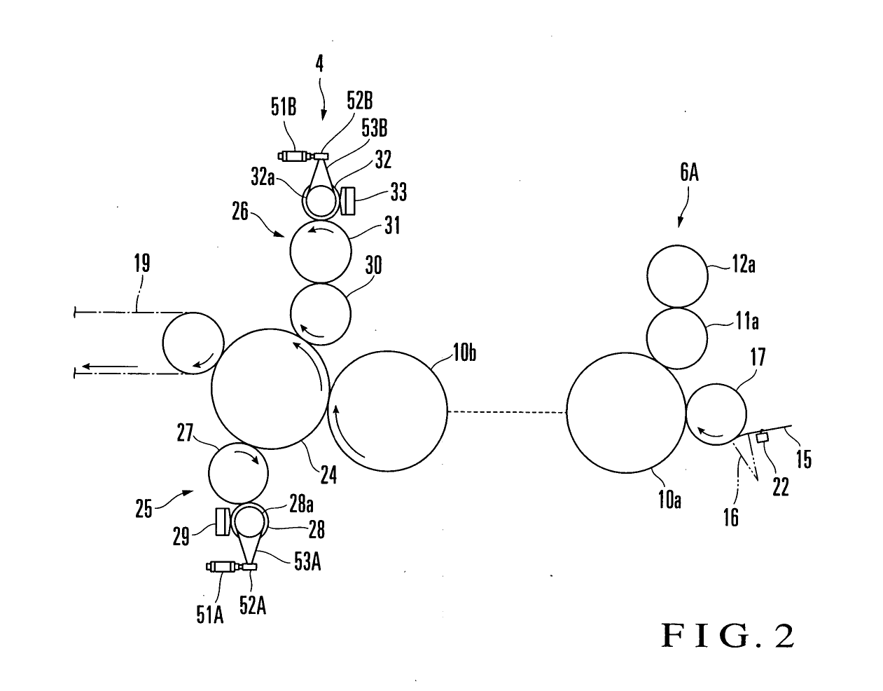

As shown in FIG. 2, a sensor 22 is arranged at the downstream front end in the sheet convey direction of the feeder board 15 and detects the presence/absence of a sheet on the feeder board 15. The coating unit 4 includes a blanket impression cylinder 24 serving as an impression cylinder which opposes the impression cylinder 10b of the reverse surface printing unit 7D, a first varnish coating device 25 which coats the reverse surface of the printed sheet, and a second varnish coating device 26 which coats the obverse surface of the printed sheet.

The first varnish coating device 25 includes a first varnish film forming cylinder 27, first anilox roller 28 (varnish supply means), and a chamber coater 29. The first varnish film forming cylinder 27 serves as a varnish supply cylinder which opposes the blanket impression cylinder 24 upstream in the sheet convey direction of the opposing point of the blanket impression cylinder 24 and impression cylinder 10b. The first anilox roller 28 opposes the first varnish film forming cylinder 27. The chamber coater 29 supplies the varnish to the first anilox roller 28. The varnish supplied from the chamber coater 29 to the first anilox roller 28 spreads to the outer surface of the blanket impression cylinder 24 through the first varnish film forming cylinder 27.

The second varnish coating means 26 includes a blanket cylinder 30, second varnish film forming cylinder 31, second anilox roller 32 (varnish supply means), and chamber coater 33. The blanket cylinder 30 serves as a varnish supply cylinder which opposes the blanket impression cylinder 24 downstream in the sheet convey direction of the opposing point of the blanket impression cylinder 24 and impression cylinder 10b. The second varnish film forming cylinder 31 serves as a varnish supply cylinder which opposes the blanket cylinder 30. The second anilox roller 32 serves as a varnish supply means which opposes the second varnish film forming cylinder 31. The chamber coater 33 supplies the varnish to the second anilox roller 32.

The varnish supplied from the chamber coater 33 to the anilox roller 32 spreads to the blanket cylinder 30 through the varnish film forming cylinder 31 and coats the obverse surface of the printed sheet which passes through the opposing point of the blanket cylinder 30 and blanket impression cylinder 24. When the sheet passes through the contact point of the blanket cylinder 30 and blanket impression cylinder 24, the varnish spreading from the varnish film forming cylinder 27 of the varnish coating device 25 to the outer surface of the blanket impression cylinder 24 coats the reverse surface of the printed sheet by the printing pressure of the blanket cylinder 30.

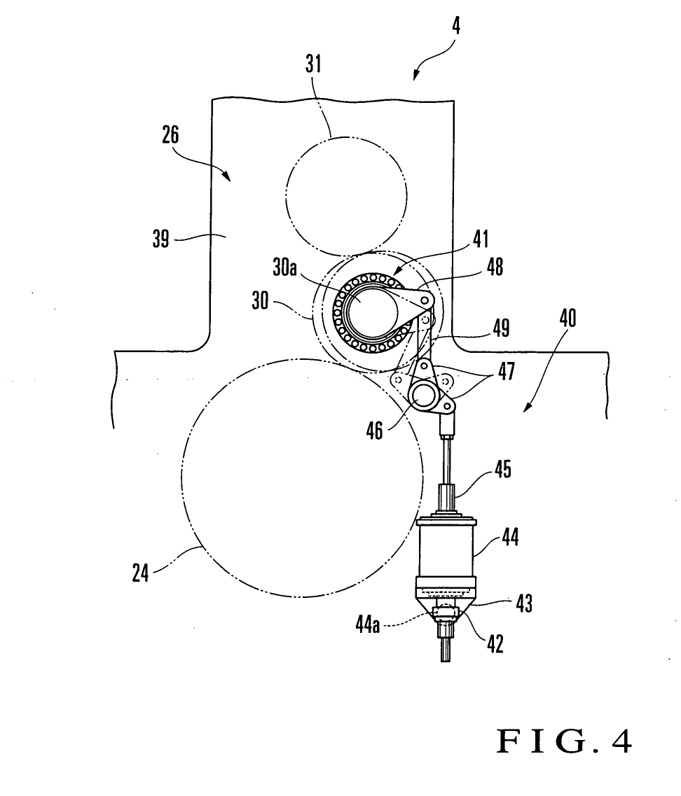

A cylinder throw on/off mechanism which throws on/off the varnish film forming cylinder 27 in the varnish coating device 25 and a cylinder throw on/off mechanism which throws on/off the blanket cylinder 30 in the varnish coating device 26 will be described with reference to FIG. 4. As these cylinder throw on/off mechanisms have the same structures, a cylinder throw on/off mechanism 40 which throws on/off the blanket cylinder 30 will only be described in detail, and the cylinder throw on/off mechanism which throws on/off the varnish film forming cylinder 27 will be described briefly when necessary.

The two end shafts of each of the blanket impression cylinder 24 and varnish film forming cylinder 31 are rotatably, axially supported by a pair of frames 39, which oppose each other at a predetermined gap, through bearings (not shown). Two end shafts 30a of the blanket cylinder 30 are rotatably, axially supported by eccentric bearings 41 (to be described later) fitted on the pair of frames 39. A stud 42 projects outwardly from one frame 39 to be close to the corresponding end shaft of the blanket impression cylinder 24. A bracket 43 is supported by the stud 42. A stepping motor 44 serving as a driving device is fixed to the bracket 43 such that its driving rod 45 stands vertically.

When the stepping motor 44 drives a nut 44a to rotate, the driving rod 45 having a threaded portion threadably engaging with the nut 44a vertically moves. Above the driving rod 45, the two ends of a lever shaft 46 are axially supported by a pair of frames 39. A connecting lever 47 having an L shape when seen from the front is axially mounted on the projecting portion of the lever shaft 46.

Each eccentric bearing 41 comprises a housing (not shown) which is fitted in the bearing hole of the corresponding frame 39, an outer ring (not shown) which fits with the housing through a needle roller, and an inner ring (not shown) which is rotatably fitted in the outer ring through a conical roller. A bearing lever 48 fixed to the outer ring of the eccentric bearing 41 is connected to the connecting lever 47 through a rod 49. When the stepping motor 44 drives the driving rod 45 to move forward/backward, the eccentric bearing 41 pivots through the connecting lever 47, rod 49, and bearing lever 48.

The axis of the inner surface of the inner ring which forms the eccentric bearing 41 and the axis of the outer surface of the outer ring of the eccentric bearing 41 are eccentric from each other by a predetermined distance. In the thrown-on state of the blanket cylinder 30, when the driving rod 45 of the stepping motor 44 moves backward, the axis of the inner surface of the inner ring moves about the axis of the outer surface of the outer ring as the center. Consequently, a gap is formed between the blanket cylinder 30 and blanket impression cylinder 24, and the blanket cylinder 30 is thrown off the blanket impression cylinder 24. The outer surfaces of the blanket cylinder 30 and varnish film forming cylinder 31 are kept in contact with each other.

A mechanism similar to that described above, which pivots the eccentric bearing (not shown) of the varnish film forming cylinder 27 of the varnish coating device 25 by the driving operation of the stepping motor 44, is also provided to the eccentric bearing. Hence, i in the varnish film forming cylinder 27 of the varnish coating means 25 as well, when the stepping motor 44 rotates to pivot the eccentric bearing, a gap is formed between the varnish film forming cylinder 27 and blanket impression cylinder 24, and the blanket impression cylinder 24 is thrown off the varnish film forming cylinder 27.

A cylinder throw on/off mechanism which throws on/off the anilox roller 28 of the varnish coating device 25 and a cylinder throw on/off mechanism which throws on/off the anilox roller 32 of the varnish coating device 26 will be described with reference to FIG. 2. The anilox roller 28 is pivotally supported by the frame 39 through an eccentric bearing 28a, and a bearing lever 53A is fixed to the outer ring of the eccentric bearing 28a. The swing end of the bearing lever 53A is pivotally mounted on a rod 52A of an air cylinder 51A pivotally mounted on the frame 39.

In this arrangement, when the air cylinder 51A is actuated to move the rod 52A forward, the eccentric bearing 28a pivots counterclockwise in FIG. 2 through the bearing lever 53A. Thus, a gap is formed between the anilox roller 28 and varnish film forming cylinder 27, and the anilox roller 28 is thrown off the varnish film forming cylinder 27. When the air cylinder 51A is actuated to move the rod 52A backward, the eccentric bearing 28a pivots clockwise in FIG. 2 through the bearing lever 53A. Thus, the anilox roller 28 comes into contact with the varnish film forming cylinder 27 and is be thrown on the varnish film forming cylinder 27.

The anilox roller 32 is pivotally supported by the frame 39 through an eccentric bearing 32a, and a bearing lever 53B is fixed to the outer ring of the eccentric bearing 32a. The swing end of the bearing lever 53B is pivotally mounted on a rod 52B of an air cylinder 51B pivotally mounted on the frame 39. In this arrangement, when the air cylinder 51B is actuated to move the rod 52B forward, the eccentric bearing 32a pivots clockwise in FIG. 2 through the bearing lever 53B. Thus, a gap is formed between the anilox roller 32 and second varnish film forming cylinder 31, and the anilox roller 32 is thrown off the varnish film forming cylinder 31.

When the air cylinder 51B is actuated to move the rod 52B backward, the eccentric bearing 32a pivots counterclockwise in FIG. 2 through the bearing lever 53B. Thus, the anilox roller 32 comes into contact with the varnish film forming cylinder 31 and is thrown on the varnish film forming cylinder 31. The printing device described above is not particularly different from the coating device of a known sheet-fed offset rotary printing press.

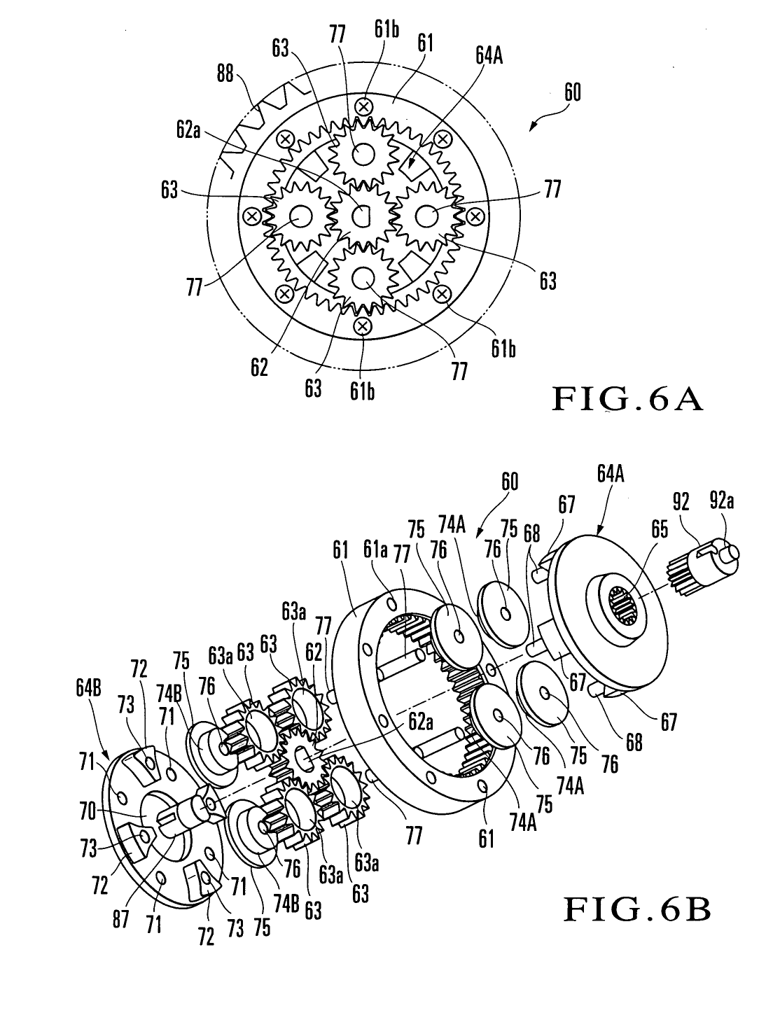

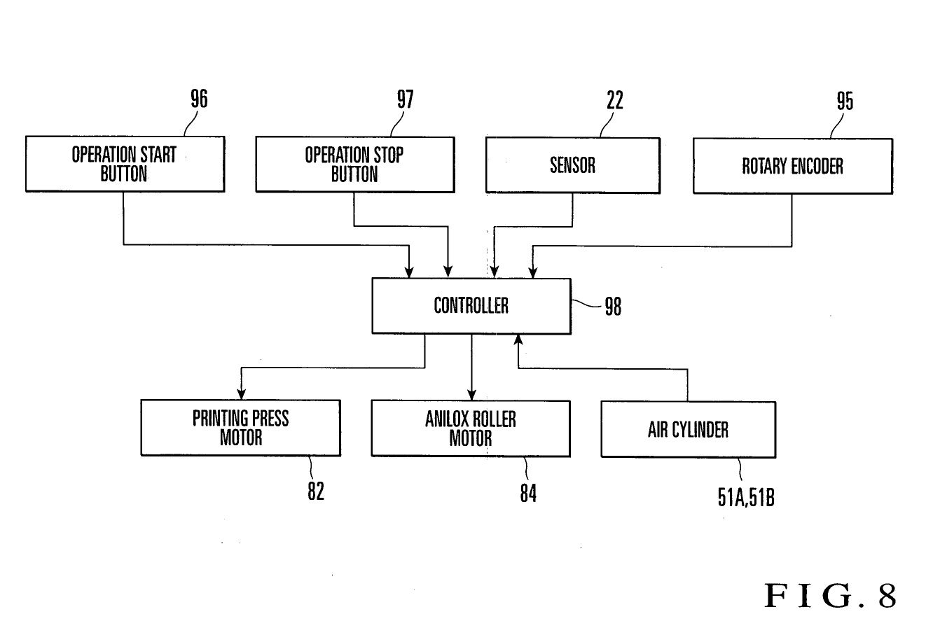

A planet gear train 60 which switches drive transmission to the anilox rollers 28 and 32 will be described with reference to FIGS. 6A and 6B. The planet gear train 60 mainly comprises a ring-like internal gear 61, sun gear 62, four planet gears 63, and a pair of carriers 64A and 64B. The internal gear 61 is driven to rotate by a printing press motor 82 (FIG. 8) serving as the first driving source. The sun gear 62 is coaxially arranged with the internal gear 61 and driven to rotate by an anilox roller motor 84 serving as the second driving source. The four planet gears 63 are arranged between the sun gear 62 and internal gear 61 and mesh with them. The pair of carriers 64A and 64B rotatably sandwich the planet gears 63 and rotate around the sun gear 62 when either one of the internal gear 61 and sun gear 62 rotates.

As is known well, a plurality of insertion through holes 61a are equidistantly formed in the side surface of the ring portion of the internal gear 61 in the circumferential direction. The sun gear 62 has a fitting hole 62a with a D-cut section at its center. Each planet gear 63 has a loose insertion hole 63a at its center. The carrier 64A has an internal gear 65 extending through its center, and four partitioning projections 67 on the rear surface of its peripheral portion. The partitioning projections 67 respectively have projecting bosses 68. Support recesses (not shown) are formed between the adjacent partitioning projections 67.

The carrier 64B has a fitting hole 70 at its center, and four support recesses 71 in the surface of its peripheral portion which opposes the carrier 64A. Four partitioning projections 72 respectively having support recesses 73 are formed between the adjacent support recesses 71. The four pairs of planet rollers 74A and 74B respectively have flanges 75, and loose insertion holes 76 at their centers.

In this arrangement, when planet rollers 74A and 74B are loosely inserted in the corresponding loose insertion holes 63a of the planet gears 63 from the two sides, the planet gears 63 are sandwiched between the two flanges 75 of the planet rollers 74A and 74B. When one end of each of four support shafts 77 which are loosely inserted in the corresponding loose insertion holes 76 of the planet rollers 74A and 74B is fitted and fixed in the corresponding support recess 71 of the carrier 64B, the planet gears 63 are rotatably supported by the carrier 64B.

At the central position of the four planet gears 63, the sun gear 62 meshes with the respective planet gears 63, and the internal gear 61 meshes with the four planet gears 63 to surround them. In this state, when the four bosses 68 of one carrier 64A are fitted and fixed in the support recesses 73 of the other carrier 64A and the other end of each support shaft 77 is fitted and fixed in the corresponding support recess of the carrier 64A, the planet gear train 60 is formed.

In the planet gear train 60 formed in this manner, the relationship among the numbers of teeth of the three gears 61, 62, and 63 is set such that when the printing press motor 82 rotates the anilox rollers 28 and 32 in a manner to be described later, the peripheral speeds of the anilox rollers 28 and 32 become equal to those of the varnish film forming cylinders 27 and 31. The relationship among the numbers of teeth of the three gears 61, 62, and 63 is set such that when both the printing press motor 82 and anilox roller motor 84 are driven simultaneously, rotation of the anilox roller 28 will not stop.

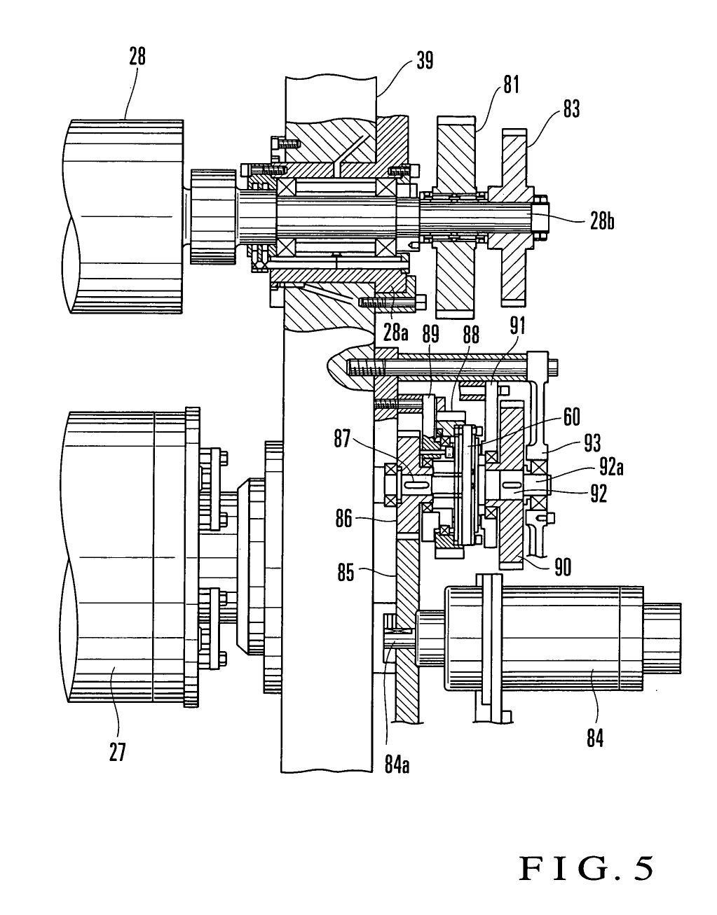

The rotary drive transmitting apparatuses of the anilox rollers 28 and 32 will be described with reference to FIGS. 5 to 8. These rotary drive transmitting apparatuses have the same structures. Thus, only the rotary drive transmitting apparatus of the anilox roller 28 will be described in detail, and that of the anilox roller 32 will be briefly described when necessary.

Referring to FIG. 5, a driving gear 81 is rotatably supported by an end shaft 28b, which projects outward from the frame 39, of the anilox roller 28, and is driven to rotate by the printing press motor 82 (see FIG. 8). A roller gear 83 is also axially mounted on the end shaft 28b of the anilox roller 28. The anilox roller motor 84 having an output shaft 84a is attached outside the frame 39. A motor gear 85 axially mounted on the output shaft 84a meshes with an intermediate gear 86 rotatably supported by the frame 39. A shaft 87 has one end with a key groove in its circumferential portion and the other end with a D-cut section. The intermediate gear 86 is axially mounted on one end of the shaft 87 through a key, and the fitting hole 62a of the sun gear 62 of the planet gear train 60 is fitted on the other end of the shaft 87. The intermediate gear 86 integrally rotates with the sun gear 62 through the shaft 87.

An intermediate gear 88 which meshes with the driving gear 81 is rotatably supported by a bearing member 89 attached to the frame 39. As shown in FIG. 6A, the intermediate gear 88 is attached to the internal gear 61 of the planet gear train 60 with screws 61b inserted in the insertion through holes 61a. As shown in FIG. 5, a transmission gear 90 which meshes with the roller gear 83 is rotatably supported by a bearing member 91 attached to the frame 39.

Referring to FIG. 5, a shaft 92 has one end with a spline formed in its circumferential portion and the other end with a key groove in its circumferential portion. A small shaft 92a projects from the end face of the other end of the shaft 92. One end of the shaft 92 meshes with the internal gear 65 of the carrier 64A of the planet gear train 60. The transmission gear 90 is axially mounted on the other end of the shaft 92 through a key, as shown in FIG. 5. The transmission gear 90 rotates integrally with the carrier 64A through the shaft 92. The small shaft 92a of the shaft 92 is rotatably supported by a bearing member 93 attached to the frame 39.

As shown in FIG. 8, a controller 98 is connected to the sensor 22, the air cylinders 51A and 51B, the printing press motor 82, the anilox roller motor 84, a rotary encoder 95 which detects the rotational positions of the respective cylinders of the printing press, an operation start button 96, and an operation stop button 97. The controller 98 actuates the air cylinders 51A and 51B when, during printing, the last sheet is gripping-changed from the swing arm shaft pregripper 16 to the grippers of the transfer cylinder 17 and the sensor 22 detects no sheet. Thus, the anilox roller 28 is thrown off the varnish film forming cylinder 27, and the anilox roller 32 is thrown off the second varnish film forming cylinder 31. Simultaneously, the controller 98 drives the anilox roller motor 84 and continuously drives the printing press motor 82. After that, when the rotary encoder 95 detects that the last sheet is delivered to the delivery unit 5, the controller 98 stops the driving operation of the printing press motor 82.

More specifically, since the last sheet is gripping-changed from the swing arm shaft pregripper 16 to the grippers of the transfer cylinder 17 and the sensor 22 detects no sheet until the last sheet is delivered to the delivery unit 5, the controller 98 drives the printing press motor 82 and anilox roller motor 84 simultaneously. After the last sheet is delivered to the delivery unit 5, when the printing press motor 82 stops driving, the controller 98 drives the anilox roller motor 84.

Hence, during the driving operation of the printing press motor 82, the anilox roller motor 84 has two states, i.e., a driving state and non-driving state. When the printing press motor 82 is kept stopped, the anilox roller motor 84 is always in the driving state. In other words, the controller 98 drives the anilox roller motor 84 at least when the printing press motor 82 is kept stopped. At the start of printing, the controller 98 stops driving the anilox roller motor 84 and drives the printing press motor 82.

A drive switching operation for the anilox rollers at the start of printing and at the end of printing of the roller rotary drive transmitting apparatus having the above arrangement will be described. First, a drive switching operation to the anilox rollers at the start of printing will be described. When the operation start button 96 is turned on, the air cylinders 51A and 51B are actuated, and the anilox roller 28 is separated from and thrown off the varnish film forming cylinder 27. Simultaneously, the anilox roller 32 is separated from and thrown off the frames 31.

The anilox roller motor 84 is driven when the printing press motor 82 is kept stopped. The rotary driving operation of the anilox roller motor 84 is transmitted to the sun gear 62 of the planet gear train 60 through the motor gear 85 and intermediate gear 86. At this time, as the driving operation of the printing press motor 82 is kept stopped, the rotation of the internal gear 61 of the planet gear train 60 which is connected to the driving gear 81 through the intermediate gear 88 is kept stopped.

Hence, when the sun gear 62 rotates, the four planet gears 63 rotate. At this time, as the rotation of the internal gear 61 which meshes with the planet gears 63 is kept stopped, the carrier 64A rotates around the sun gear 62. Thus, the transmission gear 90 attached to the carrier 64A rotates, and the anilox rollers 28 and 32 rotate through the roller gear 83 meshing with the transmission gear 90.

In this state, when the printing press motor 82 is driven to start printing, the first sheet is fed from the feed device 2 to the feeder board 15 and detected by the sensor 22. Thus, the impression cylinders 10a of the respective printing units 6A to 6D and the impression cylinders 10b of the respective printing units 7A to 7D are thrown on, and the printing units 6A to 6D and 7A to 7D print on the obverse and reverse surfaces of the sheet. After that, immediately before the printed sheet is conveyed to the coating unit 4, the controller 98 actuates the stepping motor 44 on the basis of a detection signal from the rotary encoder 95. Thus, the varnish film forming cylinder 27 is thrown on the blanket impression cylinder 24, and the blanket cylinder 30 is thrown on the blanket impression cylinder 24.

Simultaneously, the air cylinder 51A is actuated to throw the anilox roller 28 on the varnish film forming cylinder 27. The air cylinder 51B is actuated to throw the anilox roller 32 on the varnish film forming cylinder 31. Accordingly, the varnish which has been supplied from the chamber coater 29 to the anilox roller 28 is supplied to the varnish film forming cylinder 27. Simultaneously, the varnish which has been supplied from the chamber coater 33 to the anilox roller 32 is supplied to the blanket cylinder 30 through the varnish film forming cylinder 31.

When the first and second anilox rollers 28 and 32 are thrown on, the controller 98 stops driving the anilox roller motor 84 simultaneously. Until the driving operation of the anilox roller motor 84 is stopped, the anilox roller motor 84 and printing press motor 82 are driven simultaneously. At this time, since the numbers of teeth of the three gears 61, 62, and 63 are set such that the carriers 64A and 64B do not stop rotation when the internal gear 61 and sun gear 62 rotate simultaneously, the anilox rollers 28 and 32 continue rotation through the carrier 64A.

When the anilox roller motor 84 stops driving, the rotation of the sun gear 62 of the planet gear train 60 which is drive-connected to the anilox roller motor 84 through the motor gear 85 and intermediate gear 86 stops. Accordingly, the internal gear 61 of the planet gear train 60 rotates through the intermediate gear 88 which meshes with the driving gear 81 drive-connected to the printing press motor 82.

Because the four planet gears 63 are rotated by the rotation of the internal gear 61, and the rotation of the sun gear 62 which meshes with the planet gears 63 is kept stopped, the carrier 64A rotates around the sun gear 62. Thus, the transmission gear 90 which is attached to the carrier 64A rotates, and the anilox rollers 28 and 32 rotate through the roller gear 83 which meshes with the transmission gear 90. Accordingly, the anilox rollers 28 and 32 are driven by the printing press motor 82.

In this manner, the relationship among the numbers of teeth of the three gears 61, 62, and 63 of the planet gear train 60 is set such that when the anilox roller 28 is rotated by the printing press motor 82, the peripheral speed of the anilox roller 28 (32) becomes equal to that of the varnish film forming cylinder 27 (31). Thus, the varnish film thickness is not fluctuated by relative rotational fluctuation between the anilox rollers 28 and 32 and varnish film forming cylinders 27 and 31.

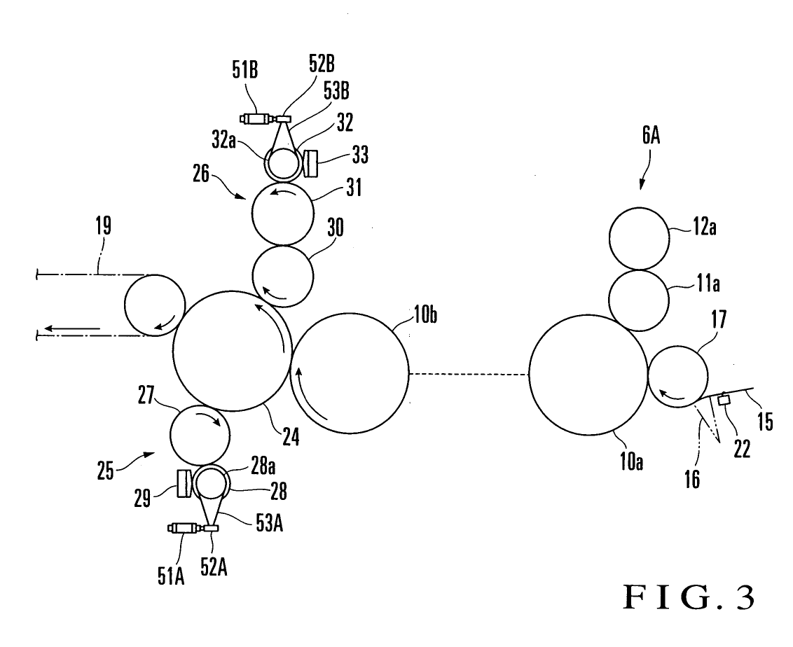

The drive switching operation to the anilox rollers at the end of printing will be described with reference to FIG. 3. When sheet feeding from the feed device 2 is ended and the last sheet is gripping-changed from the swing arm shaft pregripper 16 to the grippers of the transfer cylinder 17, the sensor 22 detects no sheet. Upon detection of no sheet, the air cylinders 51A and 51B are actuated. The anilox roller 28 is separated from and thrown off the varnish film forming cylinder 27, and the anilox roller 32 is separated from and thrown off the varnish film forming cylinder 31.

Simultaneously, when the controller 98 drives the anilox roller motor 84, the rotation of the motor 84 is transmitted to the sun gear 62 of the planet gear train 60 through the motor 85 and intermediate gear 86, and the sun gear 62 starts rotation. At this time, as the printing press motor 82 continues driving, the internal gear 61 of the planet gear train 60 which is connected to the driving gear 81 through the intermediate gear 88 also rotates.

As described above, the numbers of teeth of the internal gear 61, sun gear 62, and planet gears 63 are set such that when the internal gear 61 and sun gear 62 rotate simultaneously, the carriers 64A and 64B will not stop rotation. Therefore, the anilox rollers 28 and 32 which are impression throw-off through the carrier 64A continue rotation, so that the varnish on the anilox rollers 28 and 32 is prevented from drying.

In this state, when the last sheet sequentially passes through the printing units 6A to 6D and 7A to 7D, the respective blanket cylinders 11a and 11b are thrown off the corresponding impression cylinders 10a and 10b. When the rotary encoder 95 detects that the last sheet is delivered to the delivery unit 5, the controller 98 stops the driving operation of the printing press motor 82. Thus, the internal gear 61 of the planet gear train 60 which is drive-connected to the printing press motor 82 stops rotation, and the anilox rollers 28 and 32 are switched to be driven only by the anilox roller motor 84. After that, when the operation stop button 97 is turned on, the printing press stops driving.

In this manner, as driving switching to the anilox rollers 28 and 32 is performed by the planet gear mechanism, the teeth of the internal gear 61, sun gear 62, and planet gears 63 which mesh with each other do not slide on each other. Thus, wear resistance and durability improve. As two clutches need not be used, the manufacturing cost can be decreased.

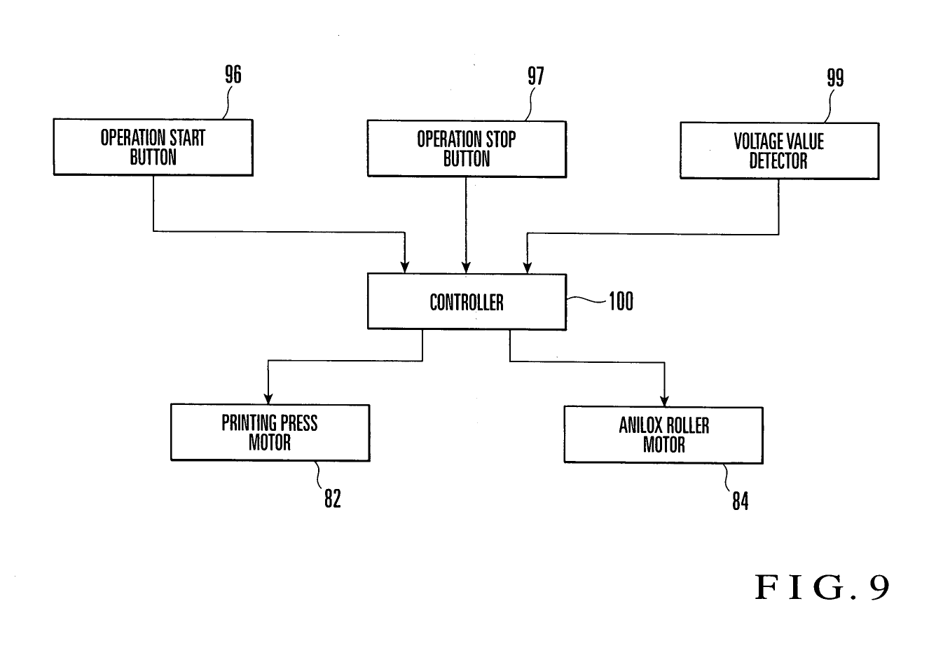

The second embodiment of the present invention will be described with reference to FIG. 9. The second embodiment is different from the first embodiment in that a voltage value detector 99 is provided in place of the sensor 22 and rotary encoder 95 shown in FIG. 8, and that the air cylinders 51A and 51B are omitted. The voltage detector 99 detects the voltage value of a printing press motor 82.

A controller 100 starts driving an anilox roller motor 84 when the detection value of the voltage value detector 99 is zero, and stops driving the anilox roller motor 84 when the detection value of the voltage detector 99 exceeds zero. More specifically, the controller 100 controls to drive the anilox roller motor 84 when the printing press motor 82 is kept stopped, and to stop driving the anilox roller motor 84 when the printing press motor 82 keeps driving. In other words, unlike the first embodiment, the printing press motor 82 and anilox roller motor 84 are not driven simultaneously.

In the above embodiments, a case has been described wherein the chamber coaters 29 and 33 supply the varnish as the varnish coating units to the anilox rollers 28 to 32. Alternatively, the varnish may be coated by a fountain roller having an outer surface partly dipped in the varnish in a varnish pan. Although the anilox roller in the coater device has been described, the preset invention can also be applied to a dampening form roller in a dampening device. Also, although the coating device has been described as a coating unit arranged between the printing unit 3 and delivery unit 5 of the sheet-fed offset rotary printing press, the coating unit may be arranged in an independent varnish coater or the like.

As has been described above, according to the present invention, since the teeth of the internal gear, sun gear, and planet gears which mesh with each other do not slide on each other, the wear resistance and durability improve. Since two clutches need not be provided and one planet gear train suffices, the manufacturing cost can be decreased.

What is claimed is:

1. A roller rotary drive transmitting apparatus comprising:
an internal gear which is rotatably driven by a first driving source;
a sun gear which is rotatably driven by a second driving source;
at least one planet gear which meshes with said sun gear and said internal gear;
a carrier which rotatably supports said planet gear and rotates around said sun gear when at least one of said internal gear and said sun gear rotates;
a roller which is connected to said carrier and rotates upon rotation of said carrier; and
control means for controlling said second driving source in an operative state while said first driving source is kept stopped.

2. An apparatus according to claim 1, wherein said control means stops said second driving source when said first driving source keeps operating in a state of at least one of printing operation and coating operation.

3. An apparatus according to claim 2, wherein said roller comprises an anilox roller which is in contact with a varnish supply cylinder.

4. An apparatus according to claim 3, further comprising throw on/off driving means for throwing said anilox roller on/off said varnish supply cylinder,
wherein said control means stops said second driving source when said anilox roller is impression throw-on said varnish supply cylinder and operates said second driving source when said anilox roller is impression throw-off said varnish supply cylinder.

5. An apparatus according to claim 3, wherein a relationship among the numbers of teeth of said internal gear, said sun gear, and said planet gear is set such that when said anilox roller rotates, a peripheral speed of said anilox roller becomes equal to that of said varnish supply cylinder.

6. An apparatus according to claim 3, wherein a relationship among the numbers of teeth of said internal gear, said sun gear, and said planet gear is set such that when said first driving source and said second drive source operate simultaneously, said anilox roller does not stop rotation.

7. An apparatus according to claim 1, further comprising voltage value detection means for detecting a voltage value of said first driving source,
wherein said control means starts driving said second driving source when the value detected by said voltage value detection means is zero and stops driving said second driving source when the value detected by said voltage value detection means exceeds zero.

8. An apparatus according to claim 1, wherein said ring-like internal gear, said sun gear arranged at the center of said internal gear, and a plurality of planet gears arranged between said sun gear and said internal gear form a planet gear train arranged among said first driving source, said second driving source, and said roller.
